(19) United States
(12) Patent Application Publication
(10) Pub. No.: US 2018/0247774 A1
(43) Pub. Date: Aug. 30, 2018

(54) Rotatable Switch Assembly

(71) Applicant: Benjamin Thang, Tulsa, OK (US)

(72) Inventor: Benjamin Thang, Tulsa, OK (US)

(21) Appl. No.: 15/441,961

(22) Filed: Feb. 24, 2017

(51) Int. Cl. H01H 3/08

(52) U.S. Cl. CPC H01H 3/08

(57) ABSTRACT

A rotatable switch assembly includes a switching unit that is electrically coupled between a power source and an electrical device. The switching unit is selectively rotated in a first direction and a second direction. Moreover, the switching unit is alternatively positioned in an on position and an off position regardless of a rotational direction of the switching unit. In this way the switching unit may be manipulated by users who are unfamiliar with toggle light switches.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to switch devices and more particularly pertains to a new switch device for turning an electrical device on and off.

### BRIEF SUMMARY OF THE INVENTION

An embodiment of the disclosure meets the needs presented above by generally comprising a switching unit that is electrically coupled between a power source and an electrical device. The switching unit is selectively rotated in a first direction and a second direction. Moreover, the switching unit is alternatively positioned in an on position and an off position regardless of a rotational direction of the switching unit. In this way the switching unit may be manipulated by users who are unfamiliar with toggle light switches.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a rotatable switch assembly in an on position according to an embodiment of the disclosure.

FIG. 2 is a front perspective view of an embodiment of the disclosure in an off position.

FIG. 3 is a front perspective view of an alternative embodiment of the disclosure in an on position.

FIG. 4 is a front perspective view of an alternative embodiment of the disclosure in an off position.

FIG. 5 is a schematic view of an embodiment of the disclosure in an on position.

FIG. 6 is a schematic view of an embodiment of the disclosure in an off position.

### DETAILED DESCRIPTION OF THE INVENTION

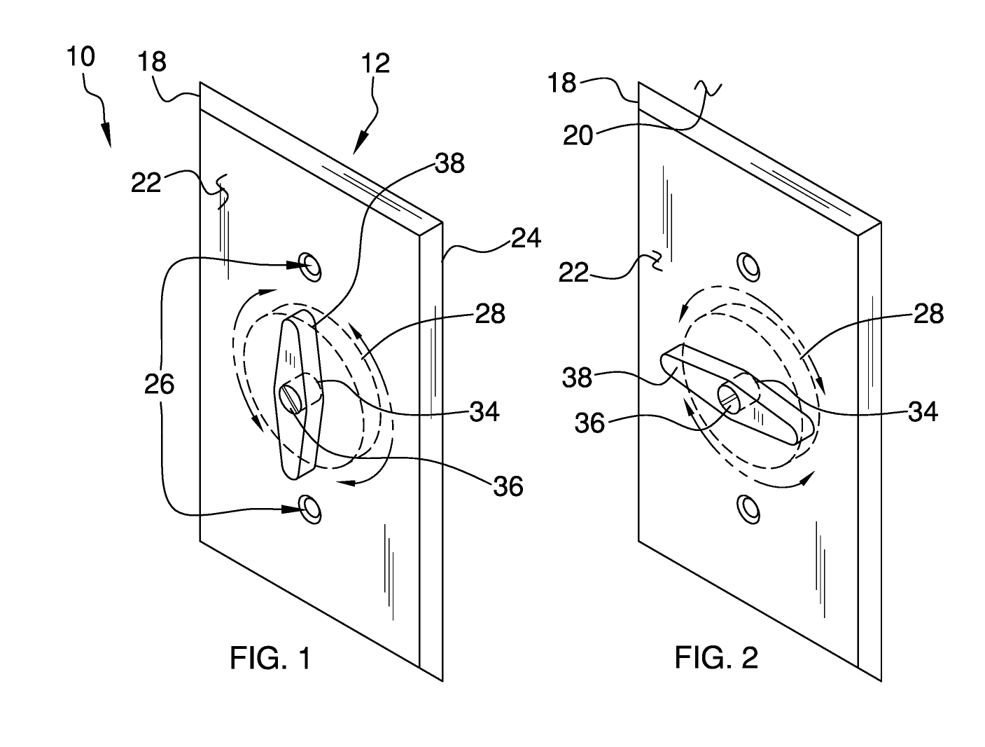

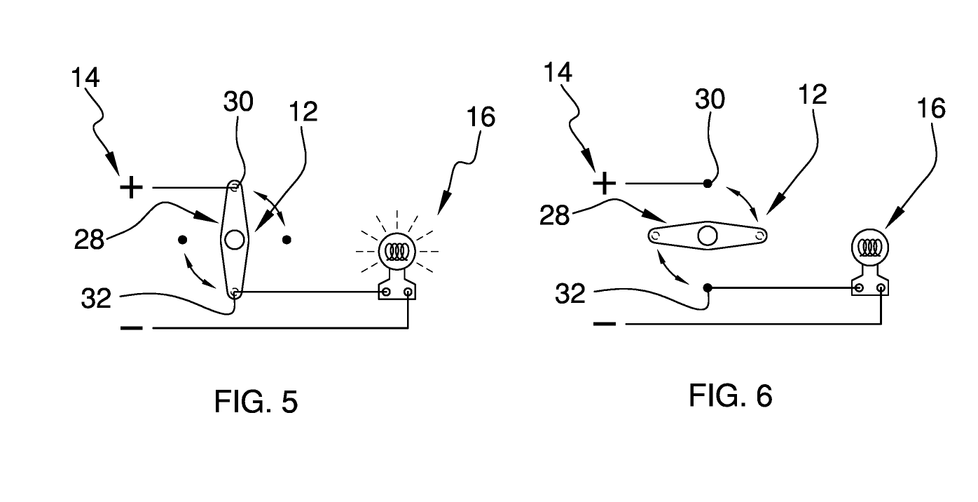

With reference now to the drawings, and in particular to FIGS. 1 through 6 thereof, a new switch device embodying the principles and concepts of an embodiment of the disclosure and generally designated by the reference numeral 10 will be described.

As best illustrated in FIGS. 1 through 6, the rotatable switch assembly 10 generally comprises a switching unit 12 that is electrically coupled between a power source 14 and an electrical device 16. The switching unit 12 is selectively rotated in a first direction and a second direction. Moreover, the switching unit 12 is alternatively positioned in an on position and an off position regardless of a rotational direction of the switching unit 12. In this way the switching unit 12 may be turned on and off by a user who is unfamiliar with toggle light switches. The power source 14 may be an electrical system in a building or the like.

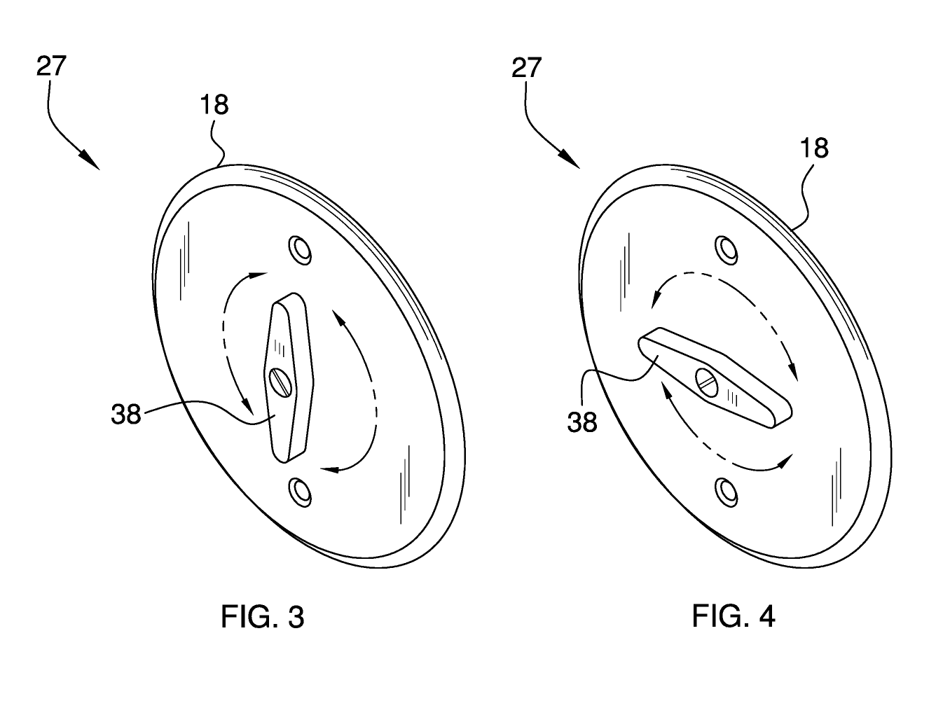

The switching unit 12 comprises a wall plate 18 that may be coupled to a vertical support surface 20. The wall plate 18 has a first surface 22 and a second surface 24 and the vertical support surface 20 may be a wall or the like. The wall plate 18 may have a pair of apertures 26 extending through the first 22 and second 24 surfaces. In this way a pair of fasteners may be extended through the apertures 26 to fasten the wall plate 18 to the vertical support surface 20. The wall plate 18 has a peripheral edge and the peripheral edge may have a plurality of intersecting sides. Thus, the wall plate 18 may have a rectangular shape. In an alternative embodiment 27 as shown in FIGS. 3 and 4, the peripheral edge may be continuous. Thus, the wall plate 18 may have a disk shape.

A switch 28 is provided and the switch 28 is coupled to the wall plate 18. The switch 28 has an input 30 and an output 32 and the switch 28 may be a rotary switch 28. The input 30 may be electrically coupled to the power source 14 and the output 32 may be electrically coupled to the electrical device 16. The input 30 is in electrical communication with the output 32 when the switch 28 is in an on position. Moreover, the input 30 is removed from electrical communication with the output 32 when the switch 28 is in an off position. The switch 28 is coupled to the second surface 24 of the wall plate 18.

A shaft 34 is coupled to the switch 28 such that the shaft 34 rotates the switch 28 between the on position and the off position. The shaft 34 has a distal end 36 with respect to the switch 28. The shaft 34 extends through the wall plate 18 and the distal end 36 is exposed on the first surface 22 of the wall plate 18. A knob 38 is coupled to the distal end 36 of the shaft 34 and the knob 38 is selectively manipulated. The knob 38 rotates the shaft 34 thereby facilitating the switch 28 to be alternatively positioned in the on position and the off position.

In use, the switch 28 is incorporated into the electrical system in the building. The knob 38 is selectively rotated in a first direction. The switch 28 is alternatively positioned in the on position and the off position when the knob 38 is rotated in the first direction. The knob 38 is selectively rotated in a second direction. The switch 28 is alternatively positioned in the on position and the off position when the knob 38 is rotated in the second direction. In this way the switch 28 is alternatively turned on and off regardless of a directional rotation of the knob 38. Such a function facilitates the switch 28 to transcend communication barriers between foreign cultures with respect to operating light switches or the like. In this way the switch 28 may be successfully manipulated by people who have never encountered a toggle style light switch 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A rotatable switch assembly being configured to be electrically coupled to an electrical device, said assembly comprising:
a switching unit being configured to be electrically coupled between a power source and an electrical device, said switching unit being selectively rotated in a first direction and a second direction, said switching unit being alternatively positioned in an on position and an off position regardless of a rotational direction of said switching unit wherein said switching unit is configured to be manipulated by a user unfamiliar with toggle light switches, said switching unit comprising
a wall plate being configured to be coupled to a vertical support surface, said wall plate having a first surface and a second surface,
a switch being coupled to said wall plate, said switch having an input and an output, said input being configured to be electrically coupled to the power source, said output being configured to be electrically coupled to the electrical device, said input being in electrical communication with said output when said switch is in an on position, said input being removed from electrical communication with said output when said switch is in an off position, said switch being coupled to said second surface of said wall plate, and
a shaft being coupled to said switch such that said shaft rotates said switch between said on position and said off position, said input and said output being diametrically positioned on opposite sides equidistant from said shaft.

2. (canceled)

3. (canceled)

4. The assembly according to claim 1, further comprising
said shaft extending through said wall plate having said distal end being exposed on said first surface of said wall plate.

5. The assembly according to claim 4, further comprising a knob being coupled to said distal end of said shaft wherein said knob is configured to be manipulated, said knob rotating said shaft when said knob is manipulated thereby facilitating said switch to be alternatively positioned in said on position and said off position.

6. A rotatable switch assembly being configured to be electrically coupled to an electrical device, said assembly comprising:
a switching unit being configured to be electrically coupled between a power source and an electrical device, said switching unit being selectively rotated in a first direction and a second direction, said switching unit being alternatively positioned in an on position and an off position regardless of a rotational direction of said switching unit wherein said switching unit is configured to be manipulated by a user unfamiliar with toggle light switches, said switching unit comprising:
a wall plate being configured to be coupled to a vertical support surface, said wall plate having a first surface and a second surface,
a switch being coupled to said wall plate, said switch having an input and an output, said input being configured to be electrically coupled to the power source, said output being configured to be electrically coupled to the electrical device, said input being in electrical communication with said output when said switch is in an on position, said input being removed from electrical communication with said output when said switch is in an off position, said switch being coupled to said second surface of said wall plate;
a shaft being coupled to said switch such that said shaft rotates said switch between said on position and said off position, said input and said output being diametrically positioned on opposite sides equidistant from said shaft, said shaft having a distal end with respect to said switch, said shaft extending through said wall plate having said distal end being exposed on said first surface of said wall plate; and
a knob being coupled to said distal end of said shaft wherein said knob is configured to be manipulated, said knob rotating said shaft when said knob is manipulated thereby facilitating said switch to be alternatively positioned in said on position and said off position.
